(19) United States
(12) Patent Application Publication
(10) Pub. No.: US 2013/0006759 A1
(43) Pub. Date: Jan. 3, 2013

(54) MONETIZING USER GENERATED CONTENT WITH EMBEDDED ADVERTISEMENTS

(75) Inventors: Prateek Srivastava, Lucknow (IN); Kevin Patel, Vadodara, Gujarat (IN)

(73) Assignee: YAHOO! INC., Sunnyvale, CA (US)

(21) Appl. No.: 13/174,992

(22) Filed: Jul. 1, 2011

(51) Int. Cl. G06Q 30/00

(52) U.S. Cl. 705/14.49

(57) ABSTRACT

A system and method are disclosed for monetizing user generated content. A user can have options for including advertising as part of their content. For example, the user may select a location, size, and shape of an advertisement for display as part of an image. An advertisement matching those attributes may be included as part of the image. The user may receive payment for displaying ads with their user generated content.

### BACKGROUND

Online advertising may be an important source of revenue for enterprises engaged in electronic commerce. Processes associated with technologies such as Hypertext Markup Language (HTML) and Hypertext Transfer Protocol (HTTP) enable a web page to be configured to display advertisements. Advertisements may commonly be found on many web sites. Web site publishers, such as news and sports web sites, may provide space for advertisements. The publishers of these web sites may sell advertising space to advertisers to defray the costs associated with operating the web sites as well as to obtain additional revenue. However, web site publishers are only a part of the information provided on the Internet. As the Internet has grown, the number of web sites has dramatically increased. Internet users now supply a significant amount of content displayed and transferred over the web including emails, images, and videos. Improved advertising may provide a way for users to monetize their content.

### BRIEF DESCRIPTION OF THE DRAWINGS

The system and method may be better understood with reference to the following drawings and description. Non-limiting and non-exhaustive embodiments are described with reference to the following drawings. The components in the drawings are not necessarily to scale, emphasis instead being placed upon illustrating the principles of the invention. In the drawings, like referenced numerals designate corresponding parts throughout the different views.

FIG. 1 is a diagram of an exemplary network system;

FIG. 2 is a diagram of another exemplary network system;

FIG. 3 is a diagram of an exemplary monetizer interface;

FIG. 4 is a diagram of exemplary advertising attributes;

FIG. 5 is a diagram of an exemplary interaction;

FIG. 6 is a screen shot of providing user generated content;

FIG. 7 is a screen shot of the user generated content;

FIG. 8 is a screen shot of attribute selection;

FIG. 9 is another screen shot of attribute selection;

FIG. 10 is a screen shot of an advertisement displayed with user generated content;

FIG. 11 is a screen shot of the ad selection interface; and

FIG. 12 is a screen shot of an exemplary embed advertisement.

### DETAILED DESCRIPTION

By way of introduction, a system and method may monetize user generated content. A user can have options for including advertising as part of their content. For example, the user may select a location, size, and shape of an advertisement for display as part of an image. An advertisement matching those attributes may be included as part of the image. The user may receive payment for displaying ads with their user generated content.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims. Nothing in this section should be taken as a limitation on those claims. Further aspects and advantages are discussed below.

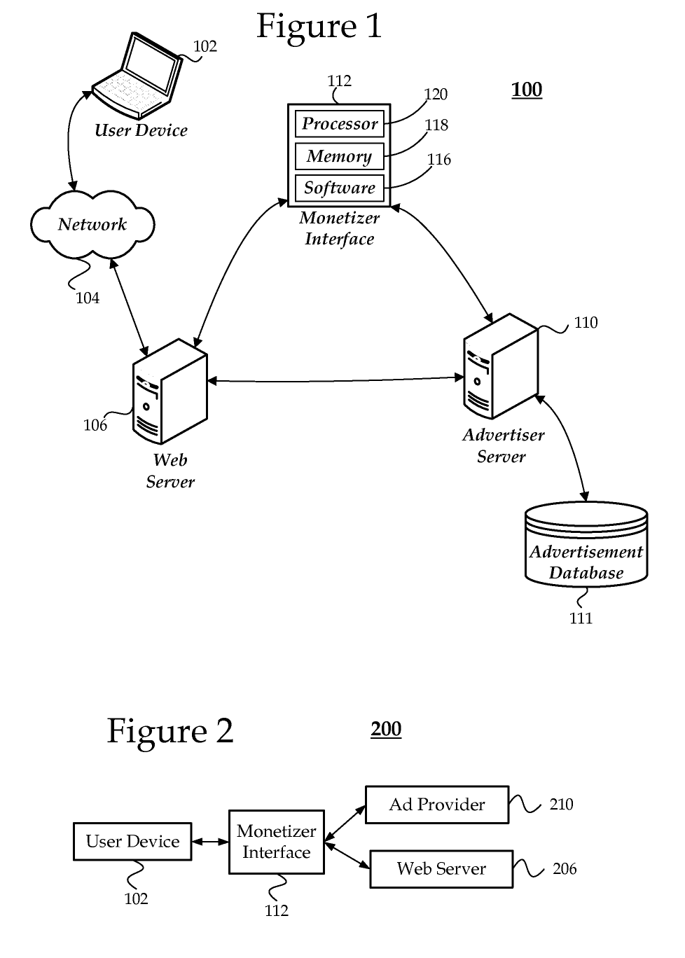

FIG. 1 depicts a block diagram illustrating one embodiment of an exemplary advertising system 100. The advertising system 100 may provide a platform for the identification, selection, and display of advertisements for user generated content included in pages, such as web pages. In the advertising system 100, a user device 102 is coupled with a web server 106 through a network 104. The web server 106 may be coupled with an advertiser server 110 which is coupled with an advertisement database 111. A monetizer interface 112 may be coupled with the web server 106 and/or the advertiser server 110. Herein, the phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided.

The user device 102 may be a computing device which allows a user to connect to a network 104, such as the Internet. As described below, a user of a user device 102 may provide user generated content (e.g. emails, web pages, photos, video, etc.) for which advertisements may be selected, embedded, and monetized. Examples of a user device include, but are not limited to, a personal computer, personal digital assistant (“PDA”), cellular phone, or other electronic device. The user device 102 may be configured to allow a user to interact with the web server 106, the monetizer interface 112, and/or other components of the advertising system 100. The user device 102 may include a keyboard, keypad or a cursor control device, such as a mouse, or a joystick, touch screen display, remote control or any other device operative to allow a user to interact with the monetizer interface 112 via the user device 102. In one embodiment, the user device 102 is configured to request and receive information from the web server 106, such as a web page, as well as provide user generated content. The user device 102 may also be configured to interact with the monetizer interface 112 for including advertisements with the user generated content. The user device 102 may be configured to access other data/information in addition to web pages over the network 104 using a web browser, such as INTERNET EXPLORER® (sold by Microsoft Corp., Redmond, Wash.) or FIREFOX® (provided by Mozilla). The data displayed by the browser may include advertisements. In an alternative embodiment, software programs other than web browsers may also display advertisements received over the network 104 or from a different source.

In one embodiment, the web server 106 provides an interface to a network 104 and/or provides a web page to the user device 102. The web server 106 may be a web server that provides the user device 102 with pages (including advertisements) that are requested by a user of the user device 102. In addition, the web server 106 may receive user generated content from the user device 102 that is then displayed or sent over the network 104 to other users with other user devices. There may be additional web servers or publishers that host and provide the user generated content. As described below, user generated content may include advertising space or advertisement slots that are filled with advertisements viewed by other users.

The advertiser server 110 may provide advertisements for display with user generated content. In one embodiment, the monetizer interface 112 provides the advertiser server 110 with the attributes for a potential advertisement and the advertisement server provides an appropriate advertisement for the user generated content based on the attributes.

The advertisement database 111 may store advertisements for display with user generated content. The stored data may also relate to or include various user information, such as preferences, interests, profile information or browsing tendencies, and may include the number of impressions and/or number of clicks on particular advertisements. The advertisement database 110 may store advertisements from a number of advertisers. In addition, the advertisement database 110 may store records on the advertisements that are shown and the resulting impressions, clicks, and/or actions taken for those advertisements. The stored data may be used by the monetizer interface 112 for selecting current and future ads for user generated content. The data may be continuously updated to reflect current viewing, clicking, and interaction with the advertisements displayed with the user generated content.

The monetizer interface 112 may receive user generated content from the user device 102 along with attributes for a potential advertisement to be displayed with the user generated content. The monetizer interface 112 may then communicate with the ad server for retrieving an advertisement based on the attributes that can be displayed with the user generated content. The advertisement may then be monitored or tracked for compensating the user who included that ad with their content. In alternate embodiments, the monetizer interface 112 may be combined with or be a part of the web server 106 and/or the advertiser server 110. Alternatively, the monetizer interface 112 may be a separate component that is accessible by the web server 106 and/or the advertiser server 110. The monetizer interface 112 may be a web interface that is accessible over the network 104 by the user device 102 and an advertiser provider (e.g. the advertiser server 110). The monetizer interface 112 may be described below as an interface between a user (providing user generated content) and an advertiser (providing advertisements for the user generated content).

The monetizer interface 112 may communicate with any of the user device 102, the web server 106, and/or the advertiser server 110. The monetizer interface 112 may be part of a separate computing device that provides an interface for a user and an advertiser to provide advertisements for display with user generated content. The computing device of the monetizer interface 112 may be a part of the web server 106, advertiser server 110, and/or the user device 102. In alternate embodiments, the monetizer interface 112 may be implemented on software, including through the web. The components described through which the monetizer interface 112 may be implemented include a processor 120, memory 118, and software 116. The monetizer interface 112 may be a separate component from the web server 106 and/or the advertiser server 110, or may be combined as a single component or device.

The processor 120 in the monetizer interface 112 may include a central processing unit (CPU), a graphics processing unit (GPU), a digital signal processor (DSP) or other type of processing device. The processor 120 may be a component in any one of a variety of systems. For example, the processor 120 may be part of a standard personal computer or a workstation. The processor 120 may be one or more general processors, digital signal processors, application specific integrated circuits, field programmable gate arrays, servers, networks, digital circuits, analog circuits, combinations thereof, or other now known or later developed devices for analyzing and processing data. The processor 120 may operate in conjunction with a software program, such as code generated manually (i.e., programmed).

The processor 120 may be coupled with a memory 118, or the memory 118 may be a separate component. The functions of the monetizer interface 112 may be stored as software 116 in the memory 118. The memory 118 may include, but is not limited to, computer readable storage media such as various types of volatile and non-volatile storage media, including random access memory, read-only memory, programmable read-only memory, electrically programmable read-only memory, electrically erasable read-only memory, flash memory, magnetic tape or disk, optical media and the like. The memory 118 may include a random access memory for the processor 120. Alternatively, the memory 118 may be separate from the processor 120, such as a cache memory of a processor, the system memory, or other memory. The memory 118 may be an external storage device or database for storing recorded ad or user data. Examples include a hard drive, compact disc (“CD”), digital video disc (“DVD”), memory card, memory stick, floppy disc, universal serial bus (“USB”) memory device, or any other device operative to store ad or user data. The memory 118 is operable to store instructions executable by the processor 120.

The functions, acts or tasks illustrated in the figures or described herein may be performed by the programmed processor executing the instructions stored in the memory 118. The functions, acts or tasks are independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like. The processor 120 is configured to execute the software 116. The software 116 may include instructions for providing an interface for a user to select, embed, and monetizer advertisements for user generated content.

In the embodiment where the monetizer interface 112 is separate computing device as illustrated in FIG. 1, the monetizer interface 112 may include interface components that may include a user input device or a display, and may include a keyboard, keypad or a cursor control device, such as a mouse, or a joystick, touch screen display, remote control or any other device operative to interact with the monetizer interface 112. The monetizer's interface may include a display coupled with the processor 120 and configured to display an output from the processor 120. The display may be a liquid crystal display (LCD), an organic light emitting diode (OLED), a flat panel display, a solid state display, a cathode ray tube (CRT), a projector, a printer or other now known or later developed display device for outputting determined information. The display may act as an interface for the user to see the functioning of the processor 120, or as an interface with the software 116 for providing input parameters.

The present disclosure contemplates a computer-readable medium that includes instructions or receives and executes instructions responsive to a propagated signal, so that a device connected to a network can communicate voice, video, audio, images or any other data over a network. An interface may be used to provide the instructions over the network via a communication port. The communication port may be created in software or may be a physical connection in hardware. The communication port may be configured to connect with a network, external media, display, or any other components in system 100, or combinations thereof. The connection with the network may be a physical connection, such as a wired Ethernet connection or may be established wirelessly as discussed below. Likewise, the connections with other components of the system 100 may be physical connections or may be established wirelessly.

Any of the components in the advertising system 100 may be coupled with one another through a network, including but not limited to the network 104. For example, the monetizer interface 112 may be coupled with the web server 106 and/or the advertiser server 110 through a network. As another example, the advertiser database 111 may be coupled with the web server 106 and/or the monetizer interface 112 through a network. Accordingly, any of the components in the advertising system 100 may include communication ports configured to connect with a network.

The network or networks that may connect any of the components in the advertising system 100 to enable communication of data between the devices may include wired networks, wireless networks, or combinations thereof. The wireless network may be a cellular telephone network, a network operating according to a standardized protocol such as IEEE 802.11, 802.16, 802.20, published by the Institute of Electrical and Electronics Engineers, Inc., or WiMax network. Further, the network(s) may be a public network, such as the Internet, a private network, such as an intranet, or combinations thereof, and may utilize a variety of networking protocols now available or later developed including, but not limited to TCP/IP based networking protocols. The network(s) may include one or more of a local area network (LAN), a wide area network (WAN), a direct connection such as through a Universal Serial Bus (USB) port, and the like, and may include the set of interconnected networks that make up the Internet. The network(s) may include any communication method or employ any form of machine-readable media for communicating information from one device to another. For example, the ad publisher server 112 or the web server 106 may provide advertisements and/or content (e.g. user generated content) over a network, such as the network 104.

The web server 106, the publisher database 110, the monetizer interface 112, the advertiser server 110, the advertiser database 111, and/or the user device 102 may represent computing devices of various kinds. Such computing devices may generally include any device that is configured to perform computation and that is capable of sending and receiving data communications by way of one or more wired and/or wireless communication interfaces. For example, the user device 102 may be configured to execute a browser application that employs HTTP to request information, such as a web page, from the web server 106. The present disclosure contemplates the use of a computer-readable medium that includes instructions or receives and executes instructions responsive to a propagated signal, so that any device connected to a network can communicate voice, video, audio, images or any other data over a network.

FIG. 2 is a diagram of another exemplary network system 200. The alternate system 200 illustrates an alternative embodiment in which the monetizer interface 112 is an interface between the user device 102 and the ad provider 210 and the web server 206. The first system 100 illustrated the monetizer interface 112 as a separate computing device coupled with the web server and ad server that communicated with the user device 102 through the network 104. The alternate system 200 illustrates the monetizer acting as an interface. In alternate embodiments, the monetizer interface 112 may be part of the user device 102, the web server 206, and/or the ad provider 210. In alternative embodiments, the monetizer interface 112 may be a web interface accessible by the user device 102 when a user is uploading user generated content. In that embodiment, the user utilizes the monetizer interface 112 to identify ad attributes for a potential advertisement to be included in that user's generated content. The ad provider 210 uses the identified ad attributes to select an advertisement to be included with the user generated content.

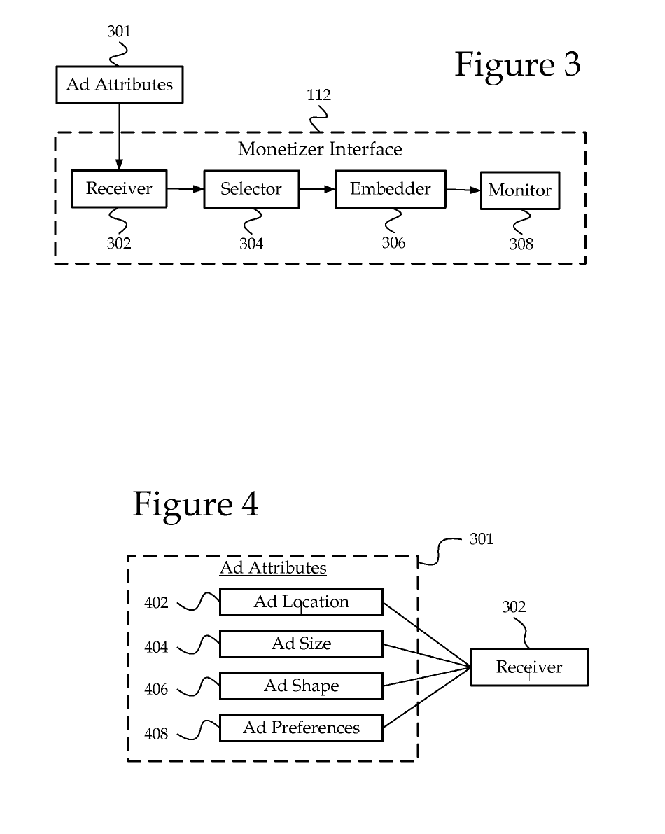

FIG. 3 is a diagram of an exemplary monetizer interface 112. The monetizer interface 112 may be a web interface and the ad attributes 301 may be entries from the user on the web page that are provided to an ad provider where the attributes are used for the selection of an advertisement. The monetizer interface 112 may include a receiver 302, selector 304, embedder 306, and a monitor 308. The receiver 302 receives ad attributes 301 from the user. The ad attributes 301 are further described with respect to FIG. 4. The selector 304 may utilize the ad attributes 301 for identifying and selecting an advertisement to be displayed.

The selector 304 may consider the ad attributes 301 as well as information about the content and/or the user. In one embodiment, audience information may be used for selecting an advertisement that profiles a potential audience that views the content and the advertisement. The audience information may also be referred to as user information, but relates to an audience that views the user generated content. The profile may include user behavior with regard to ads for tracking the advertising features each user may be more likely to respond. Additionally, data about the time of day, colors, shopping items, webpage content, and purchase data as they relate to advertisement interaction may be included for the profiling. An audience profile may keep track of average age, zip code, email address, occupation, income level, industry, gender, ethnographic information, purchase history, and/or personal interests of users that click through a particular advertisement.

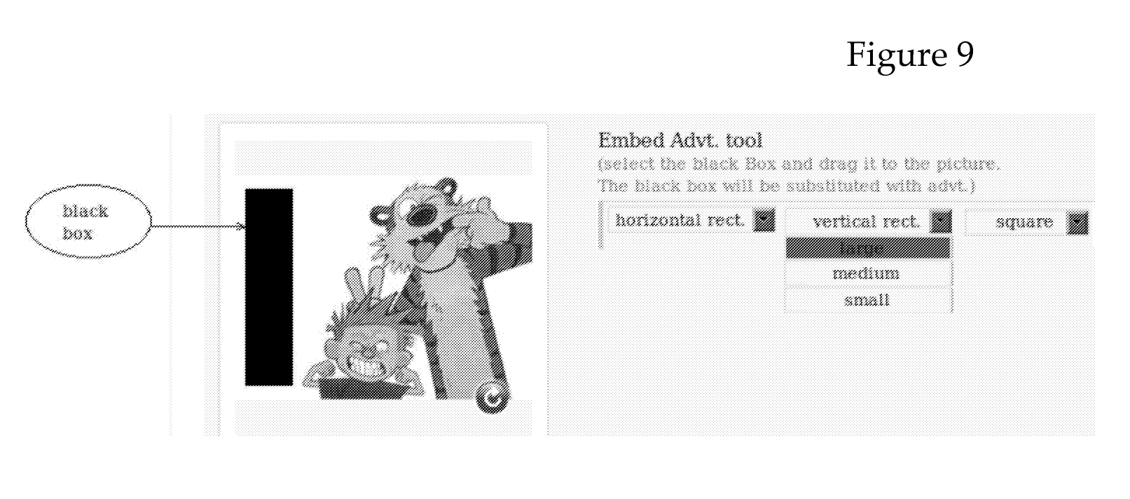

The ad may be selected differently in different embodiments. The user may specify the size of the ad and the location of the ad, which narrows selection of the ad. The user may be given control over the types of ads that may be selected by specifying certain attributes (e.g. a user can blacklist a category, such as adult content). Other attributes from the user may include transparency and color. The user may be presented with a black box (e.g. FIG. 9) that may be dragged and placed within or next to the user generated content. An intelligence engine (e.g. monetizer interface) may select an appropriate size ad from the ad database and replace the black box with the selected ad. The embedded ads may be relevant to the context of the content. The context of images and videos may be determined from their tags, title, or description metadata. Due to privacy concerns regarding email messages, it may not be easy to determine the context of the email in order to select an ad to appear in the email. Depending on privacy concernts, the content of an email message may be used for selecting an advertisement, otherwise, targeting information about the recipient may be used for selecting the ad. In other words, the embedded ad in an email may be relevant to the recipient rather than the context of the email message. Targeting based on the profile of the viewer may be used for images and/or videos in addition to email messages.

The selected advertisement may be embedded in the user content by the embedder 306. The monitor 308 then monitors the display of the advertisement in the user content for providing compensation to the user. For example, the user may be compensated based on impressions or clicks of the advertisement when displayed with the user generated content. In alternative embodiments, the illustrated components of the monetizer interface 112 may be disposed in other locations. For example, the selector 304, the embedder 306, and the monitor 308 may be part of the ad server or ad provider. Alternatively, the embedder 306 may be part of the publisher of the user generated content because the advertisement is included with the published user generated content. In alternative embodiments, the user generated content is an email and the advertisement may be added to the emails, in which case the embedder 306 may be the email provider or email software.

FIG. 4 is a diagram of exemplary advertising attributes 301 that are provided to the receiver 302. The ad attributes may include location 402, size 404, shape 406, and/or preferences 408. The ad location 402 may refer to the position of the advertisement relative to the user generated content. For example, the advertisement may be displayed above, below, beside, or within the user generated content. The ad size 404 may refer to the size of the advertisement slot in which the advertisement is displayed. For a large user generated image, the ad may also be large. Conversely, small user generated content may be overwhelmed by a large ad and a small ad would be more appropriate. The ad shape 406 may refer to a square, rectangular, circular, or other shape in which the ad appears. For example, the ad shape may be a rectangle next to the user generated content, or be a rectangle above the user generated content (e.g. a banner ad). The ad preferences 408 may include when and where the ad is displayed. The user may control when the ad is displayed with the user generated content. For example, first time visitors may not be shown any ads, but subsequent views of a page may result in the ads being included.

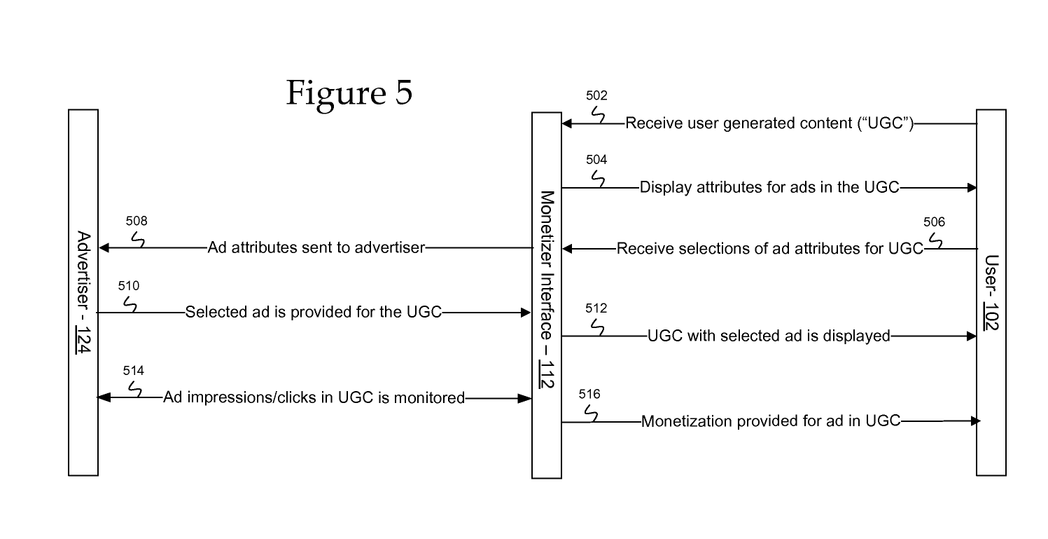

FIG. 5 is a diagram of an exemplary interaction. The interaction in FIG. 5 illustrates the communications between the user 102 and advertiser 124 with the monetizer interface 112. In step 502, the user provides user generated content. In step 504, the monetizer interface 112 may display potential attributes for the display of an advertisement with user generated content In step 506, the user selects the attributes for the advertisement. In step 508, the selected ad attributes are sent to the advertiser 124. Based on the ad attributes, an advertisement is selected in block 510. In block 512, the user generated content with the selected ad is displayed. Impressions or clicks of the advertisement are monitored in block 514 and compensation for the display of the advertisement is provided in step 516. The compensation may be based on the impressions of the ad or based on a price/cost per click. The compensation of the user displaying the advertisement may also be referred to as monetization.

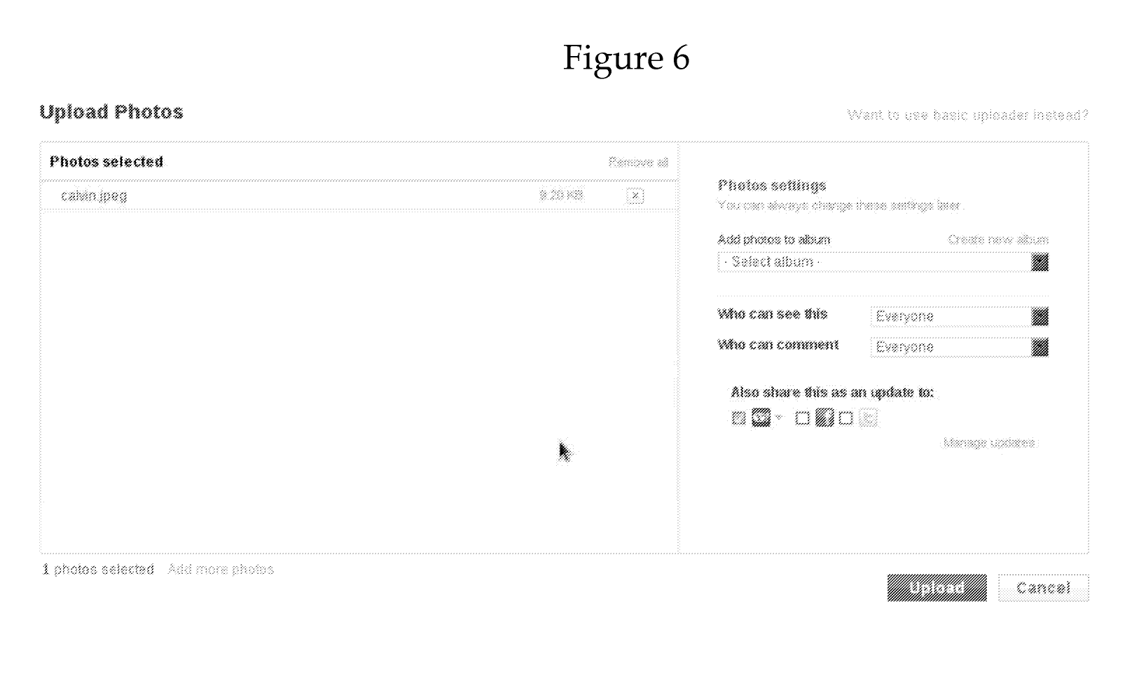

FIG. 6 is a screen shot of providing user generated content. As shown in FIG. 6, the user is uploading user content, which in this example is a photo entitled calvin.jpeg. The photo may be displayed on a user page and is one example of user generated content. An example of ad preferences 408 may include the photo settings in which the display of the user generated content may be restricted. For example, only certain users may be able to view the photo.

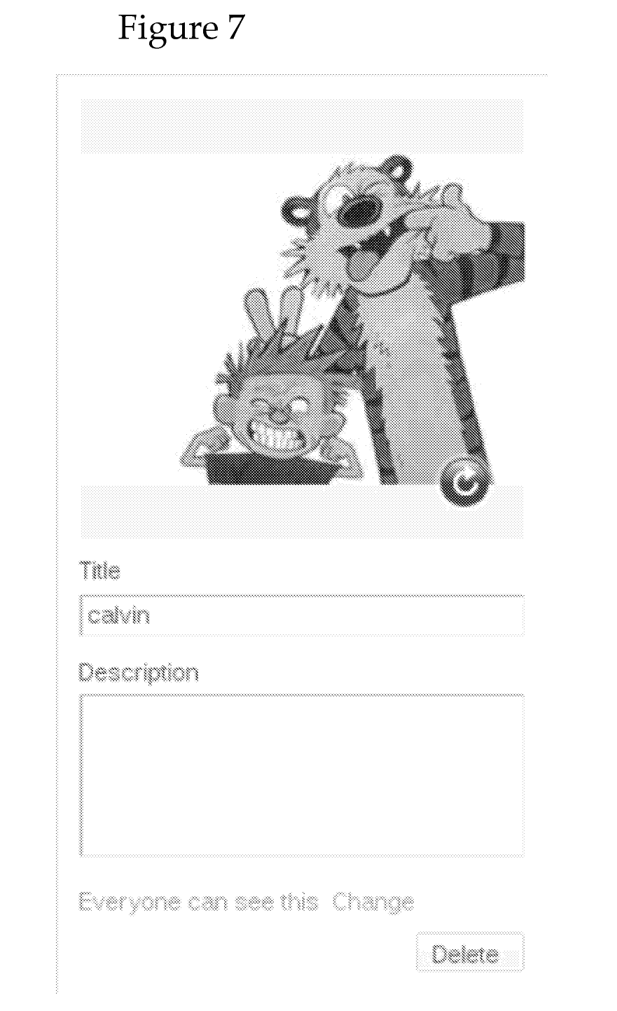

FIG. 7 is a screen shot of the user generated content. The user generated content is a picture that is displayed. The picture includes metadata such as a title and description. The user generated content metadata may be used for the selection of the advertisement that may be displayed with the user generated content. Additional metadata may be specific to the publisher of the content (e.g. FLICKR, FACEBOOK, or PULSE may have title, description, geo-location, and tags.

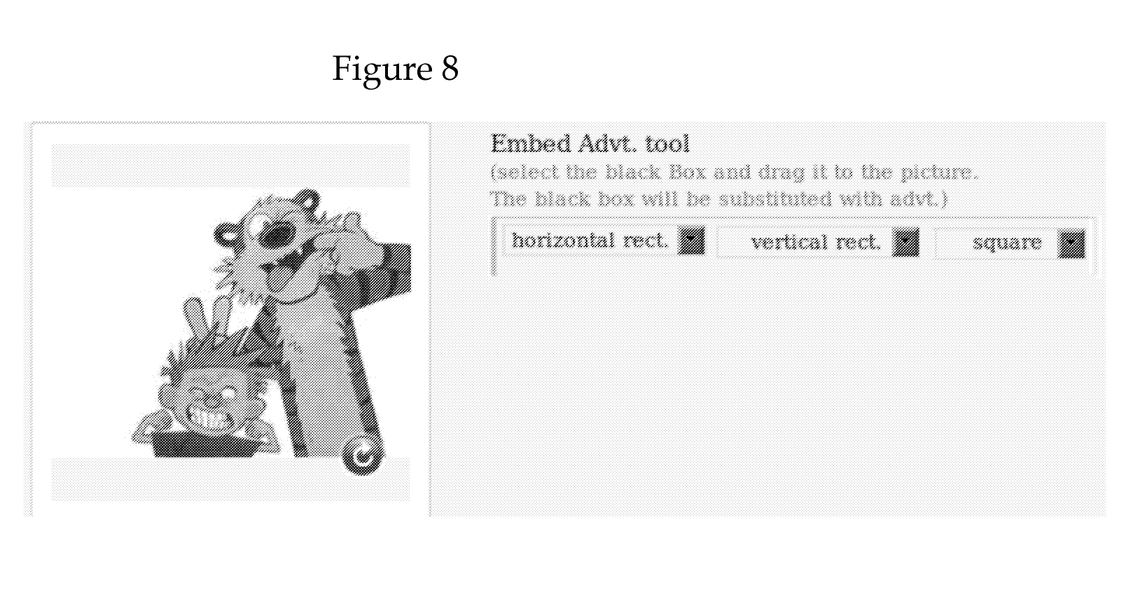

FIG. 8 is a screen shot of attribute selection. The user may be given an option of adding an advertisement to his/her user generated content. In FIG. 8, the user has agreed to include an advertisement with his/her content. The user is choose various attributes that establish the parameters of the advertisement. As shown, there are three drop-down boxes with different shapes and sizes of ad slots in which the advertisement will be placed. The user can choose from a horizontal rectangular advertisement, a vertical rectangular advertisement, or a square advertisement.

FIG. 9 is another screen shot of attribute selection. As shown, the user has selected a vertical rectangular advertisement. The user can select the size attribute for the advertisement. The user has selected a large advertisement to be displayed. The advertisement slot in which the advertisement will be displayed is displayed as a black box relative to the user generated content. The interface display as shown in FIG. 9 allows the user to adjust or modify the ad slot (black box) relative to the user generated content.

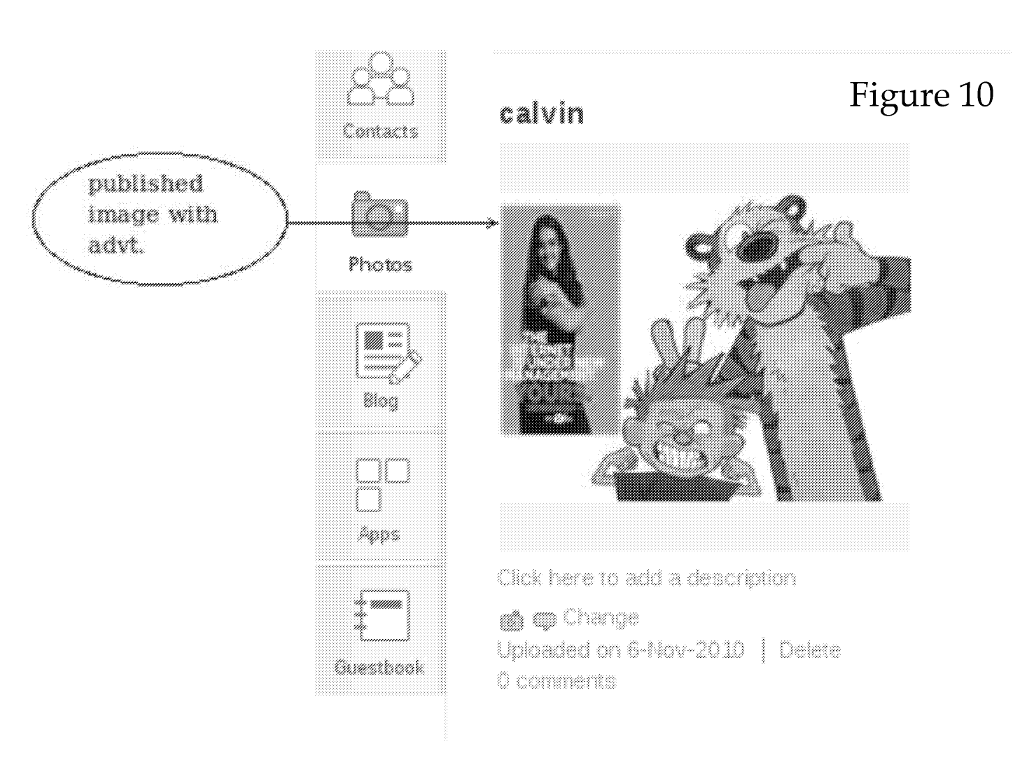

FIG. 10 is a screen shot of an advertisement displayed with user generated content. The ad slot from FIG. 9 illustrated the user selected position, shape, and size of the advertisement. An advertisement may be selected that matches the position, shape, and size attributes provided by the user. The ad is displayed with the user generated content. In this example, the advertisement is displayed next to the “calvin” image.

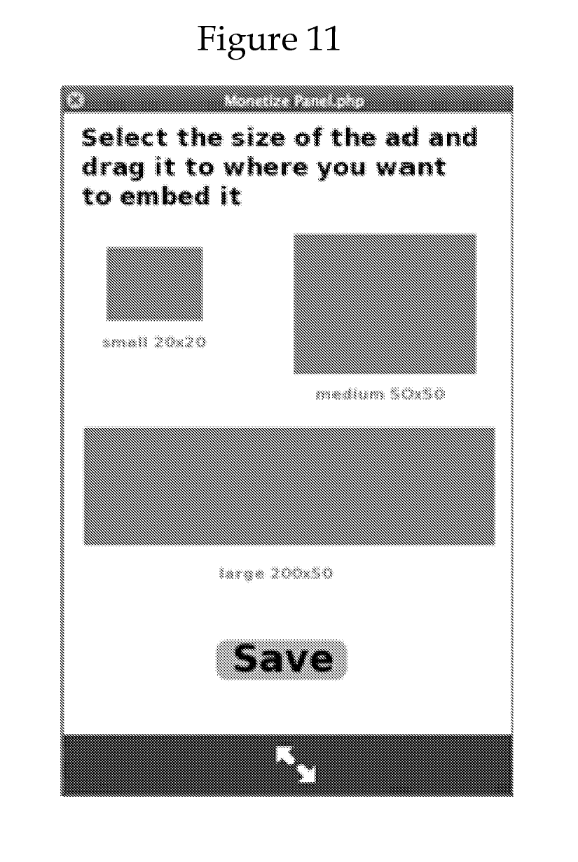

FIG. 11 is a screen shot of the ad selection interface. In particular, the user may click a monetize button when uploading an image/video, or when sending an email. The monetize button selection may bring up a user interface panel as shown in FIG. 11 from which the user selects the size and location of an ad to be embedded with the user's image/video/email. In one embodiment, the user drags and drops one of the boxes from FIG. 11 (one of the small, medium, or large boxes) onto or next to the user's image/video/email. In other embodiments, the ad may be different sizes and also different shapes than the examples shown in FIG. 11.

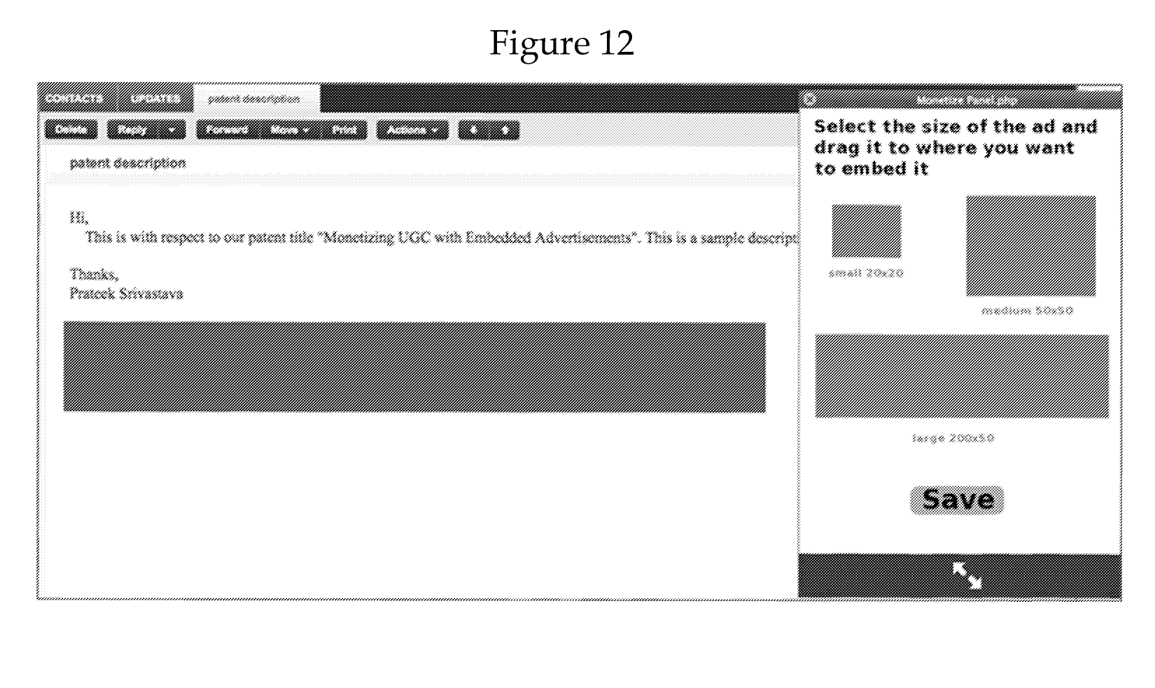

FIG. 12 is a screen shot of an exemplary embed advertisement. In particular, the user may drag and drop the large advertisement from the ad selection interface of FIG. 11 onto an email message as shown in FIG. 12. The user selects the size and location of the advertisement. As discussed above, the particular advertisement that is shown in that slot is based on various attributes which may include the content of the email and/or a user profile. FIG. 12 illustrates an example of an email message that is embedded with an advertisement, but any other user generated content may also have an embedded advertisement, such as images or videos as discussed above.

A “computer-readable medium,” “machine readable medium,” “propagated-signal” medium, and/or “signal-bearing medium” may comprise any device that includes, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

We claim:

1. A method for providing an ad in user generated content, the method comprising:
receiving attributes for an ad slot that is part of the user generated content;
analyzing the attributes and the user generated content;
selecting an advertisement based on the analysis of the attributes and the user generated content, wherein the selected advertisement is included in the ad slot that is part of the user generated content;
monitoring display and interaction of the selected advertisement; and
compensating the user based on the display and the interaction of the selected advertisement.

2. The method of claim 1 wherein the attributes comprise at least one of an ad location, an ad size, an ad shape, and ad preferences.

3. The method of claim 1 wherein the analysis of the user generated content includes user information and the user information comprises demographics, geography, behavior, browsing, ad clicks, purchase history, or combinations thereof.

4. The method of claim 1 wherein the user generated content comprises at least one of an email, web page, picture, or video.

5. The method of claim 4 wherein the user generated content comprises an email and the ad slot is part of the email message.

6. The method of claim 1 wherein the interaction compensation comprises a cost per click.

7. The method of claim 1 wherein the display compensation comprises compensation for impressions.

8. The method of claim 1 further comprising providing a web interface for the receipt of the attributes for the ad slot.

9. The method of claim 8 wherein the web interface displays the user generated content with the ad slot and the ad slot can be adjusted and moved relative to the user generated content.

10. The method of claim 9 wherein the adjustments and the movement relative to the user generated content comprise exemplary attributes that are provided and analyzed for the selection of the advertisement.

11. A non-transitory computer readable medium having stored therein data representing instructions executable by a programmed processor for monetizing user generated content, the storage medium comprising instructions operative for:
providing an interface for displaying the user generated content;
providing an ad slot for displaying relative to the user generated content;
receiving an indication of attributes for the ad slot;
selecting, based on the indication of attributes, an advertisement for display in the ad slot with the user generated content;
displaying the user generated content with the advertisement; and
providing compensation based on the display of the advertisement.

12. The computer readable medium of claim 11 wherein the ad slot can be resized and repositioned relative to the user generated content and the resizing and repositioning are part of the attributes for the ad slot.

13. The computer readable medium of claim 11 wherein the user generated content comprises at least one of an email, web page, picture, or video.

14. The computer readable medium of claim 11 wherein the ad slot can be removed from the user generated content.

15. The computer readable medium of claim 11 wherein the attributes comprise at least one of an ad location, an ad size, an ad shape, and ad preferences.

16. The computer readable medium of claim 11 wherein the compensation is based on impressions or clicks of the advertisement.

17. A system for displaying an advertisement with user generated content over a network comprising:
an advertisement provider coupled with a web server over the network; and
an interface coupled with the advertisement provider and the web server, the interface comprising:
a receiver for receiving attributes regarding an ad slot within the user generated content;
a selector for selecting the advertisement based on the received attributes;
an embedder for embedding the advertisement with the user generated content; and
a monitor for tracking a display of the advertisement wherein compensation is based on tracked display of the advertisement.

18. The system of claim 17 wherein the embedder adds the advertisement to the user generated content.

19. The system of claim 17 wherein the attributes comprise at least one of an ad location, an ad size, an ad shape, and ad preferences.

20. The system of claim 19 wherein the attributes are received from a user over the network.
